(19) United States
(12) Patent Application Publication
(10) Pub. No.: US 2011/0250513 A1
(43) Pub. Date: Oct. 13, 2011

(54) FUEL CELL

(76) Inventor: Jun Akikusa, Ibaraki (JP)

(21) Appl. No.: 12/674,976

(22) PCT Filed: Aug. 26, 2008
(86) PCT No.: PCT/JP2008/002304

§ 371 Date: Jul. 5, 2011

(30) Foreign Application Priority Data
Aug. 27, 2007 (JP) 2007-220064

(51) Int. Cl. H01M 8/06

(52) U.S. Cl. 429/408

(57) ABSTRACT

The objective of the present invention is to provide a fuel cell capable of efficient heat recovery and effective temperature control in a fuel cell stack. In order to achieve the object stated above, there is provided an internal reforming type fuel cell (1) in which a fuel cell stack (3) constructed by laminating a plurality of power generation cells is placed in a container (2a) having heat insulating layer (18) on the outer side thereof, and reactant gas is supplied to an inside of the fuel cell stack (3) at the time of operation to cause power generating reaction. A vapor generator (30) for generating fuel-reforming steam utilizing exhaust heat from the fuel cell stack (3) as a heat source is mounted on a wall of the container (2a).

### TECHNICAL FIELD

The present invention relates to a fuel cell capable of efficient heat recovery and effective temperature control in a fuel cell stack.

### BACKGROUND ART

So far, a fuel cell, which directly converts chemical energy of fuel into electric energy, has drawn attention as a clean and efficient power generating device. Especially, a solid oxide fuel cell has a lot of advantages that its power generation efficiency is high and exhaust heat can be utilized effectively since its operating temperature is high compared to that of the other fuel cells. Thus, the solid oxide fuel cell has been developed as a third generation fuel cell for power generation.

The solid oxide fuel cell has a laminated structure in which a solid electrolyte layer made of an oxide ion conductor is sandwiched between an air electrode layer and a fuel electrode layer. At the time of power generation, oxygen is supplied to the air electrode side, and fuel gas (H₂, CO, CH₄ or the like) is supplied to the fuel electrode side, as reactant gases.

In the power generation cell, the oxygen (for example, air) supplied to the air electrode layer side reaches near the boundary with the solid electrolyte layer through the pore in the air electrode layer, and there, the oxygen receives an electron from the air electrode layer to be ionized to oxide ion (O²⁻). The oxide ion is diffusively moved in the solid electrolyte layer toward the fuel electrode layer. When reaching near the boundary with the fuel electrode layer, the oxide ion reacts there with fuel gas to emit an electron to the fuel electrode layer, and then reaction products such as H₂O and CO₂ are discharged to the outside of the power generation cell. The electrons obtained by the electrode reaction are taken out as an electromotive force by an external load on another route.

In an internal reforming type fuel cell which performs fuel gas reforming in the module, a vapor generator (water carburetor) is installed along with a reformer, and high-temperature steam for steam-reforming reaction is generated utilizing high-temperature exhaust gas from the fuel cell stack (See Patent Document 1).

Patent Document 1 discloses a structure in which the vapor generator is located at a position that is below the module and thermally isolated from inside of the module, and at this position, a heat-exchange process is performed with the exhaust gas. Therefore, high-temperature steam can be obtained without decreasing temperature in the module.

Such a structure is quite effective for realizing stable power generating operation in heat recovery system of the fuel cell such as a solid oxide fuel cell which requires high operating temperature and has low thermal margin. In the system, heat of the exhaust gas is recovered as a heat source for causing a reforming reaction (endoergic reaction), preheating air and fuel gas, and rising temperature of the fuel cell stack, as well as for generating steam described above.

Recently, however, high power and large scale fuel cells have been developed, and calorific value in the module tends to increase. As a result, inside of the module has been in a state of heat surplus. Accordingly, temperature control (heat release) is required for keeping inside of the module at optimum operating temperature, contrary to the conventional fuel cell.

In general, air cooling is utilized for controlling temperature of the fuel cell. In case of air cooling, when a supply of airflow is increased in accordance with heat surplus tendency described above, electric consumption of a compressor or a blower for supplying air is increased, and by such an electric consumption, electric power generated in the fuel cell is wasted.

In some cases, a radiating member such as a radiating plate or a radiating fin is attached to the fuel cell stack in order to improve efficiency of heat release. However, such a radiating member is limited in radiating capacity, and there arises a problem that fuel cell stack grows in size by attaching the radiating member.
Patent document 1: Japanese Patent Laid-Open No. 2007-005133

### DISCLOSURE OF THE INVENTION

In view of the above-described problems, an object of the present invention is to provide a fuel cell which can perform efficient heat recovery and effective temperature control in a fuel cell stack, by mounting a vapor generator on an inner wall of a housing.

According to the present invention, there is provided an internal reforming type fuel cell comprising: a fuel cell stack constructed by laminating a plurality of power generation cells; and a container accommodating a fuel cell stack therein, wherein reactant gas is supplied to an inside of the fuel cell stack at the time of operation to cause power generating reaction, the fuel cell comprising: a vapor generator, mounted on a wall of the container, for generating fuel-reforming steam by utilizing exhaust heat from the fuel cell stack as a heat source.

The vapor generator may have a water flow path which allows externally-supplied water to flow along a surface of the wall of the container. In this structure, a bottom portion of the water flow path may be sloped.

In the fuel cell, conductive beads can be filled in the vapor generator.

Further, the vapor generator can be mounted on either an inner surface or an outer surface of the container.

In addition, it is desired that a steam buffer tank be disposed above the vapor generator for temporarily storing the steam from the vapor generator.

Further, the present invention is applicable to a solid oxide type fuel cell having a seal-less structure which can discharge the exhaust gas from the outer circumferential part of the power generation cell.

According to the present invention, since a vapor generator is mounted on a wall of the container, the vapor generator can receive exhaust heat radiated from the stack efficiently through the wall acting as a heat transfer surface to generate high-temperature steam, and control and keep inside of the container, which tends to be in a state of surplus heat, at favorable operating temperature by the radiating effect due to evaporation.

In particular, the vapor generator, which has a water flow path permitting the supplied water to flow along a surface of the wall of the container, can receive conductive heat from the wall effectively and thus rapidly change water into steam.

In addition, by sloping a bottom portion of the water flow path, water in the water flow path is concentrated at the bottom for stable evaporation of an expected amount of water, when less amount of water than expected is contained in the vapor generator.

Further, when conductive beads are filed in the vapor generator, heat exchanging performance can be improved by a heat transfer effect of the conductive beads, and water in the vapor generator can be changed into steam rapidly to thereby secure a stable amount of steam.

When the vapor generator is mounted on an inner wall of the container, the vapor generator can receive radiation heat directly radiated from the fuel cell stack together with conductive heat from the container wall. As a result, heat exchanging performance can be improved and therefore the vapor generator can be downsized.

On the other hand, when the vapor generator is mounted on an outer wall of the container, heat insulating performance of the container wall can be improved. Therefore, when heat insulating material is mounted on the outside of the container, the thickness of the heat insulating material can be reduced, so that the fuel cell can be downsized.

When a steam buffer tank is arranged above the vapor generator, temperature of steam is increased since steam remains temporarily at the point. Thus, high-temperature steam can be obtained.

### BRIEF DESCRIPTION OF THE DRAWINGS

FIG. 1 is a side view showing an internal configuration of a solid oxide fuel cell according to the present invention;

FIG. 2 is a view showing a configuration of a main part of a fuel cell stack;

FIG. 3 is a view showing an embodiment in which a vapor generator is mounted on the outer surface of the side wall of an inner can body;

FIG. 4 is a view showing a configuration example of the vapor generator;

FIGS. 5A and 5B are views showing inside of a water flow path of the vapor generator;

FIG. 6 is a view showing an embodiment in which the vapor generator is mounted on the ceiling wall of the inner can body; and

FIG. 7 is a view showing a further embodiment in which the vapor generator is mounted on the bottom wall of the inner can body.

### DESCRIPTION OF THE REFERENCE NUMERALS

1 Fuel cell (Solid oxide fuel cell)
2a Container (Inner can body)
2a1-2a3 Wall
3 Fuel cell stack
7 Power generation cell
18 Heat insulating layer (Heat insulating material)
30 Vapor generator
31 Steam buffer tank
32 Water flow path
33 Bottom portion
34 Beads (Ceramic beads)

### BEST MODE FOR CARRYING OUT THE INVENTION

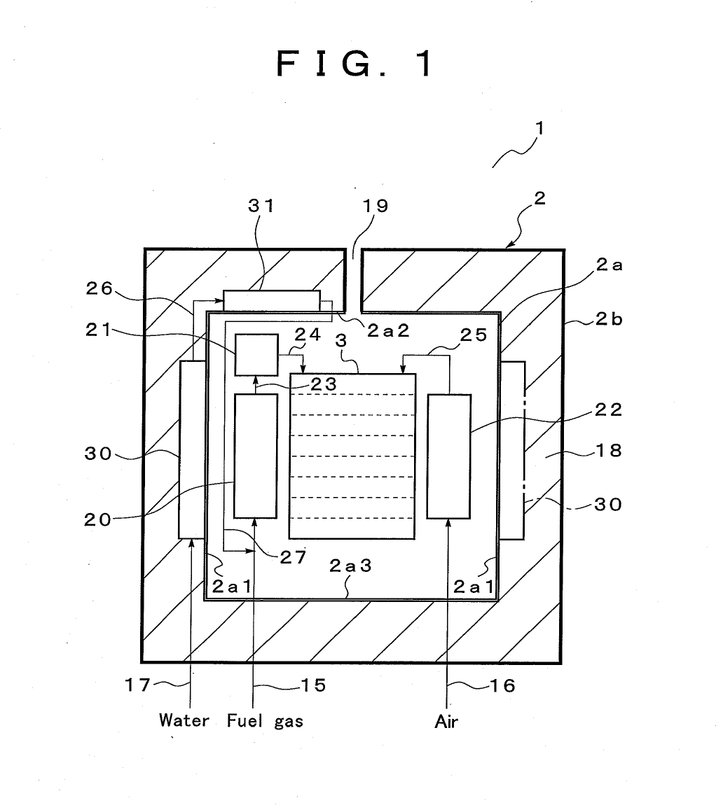

An embodiment of a fuel cell according to the present invention will be described below with reference to FIGS. 1-7.

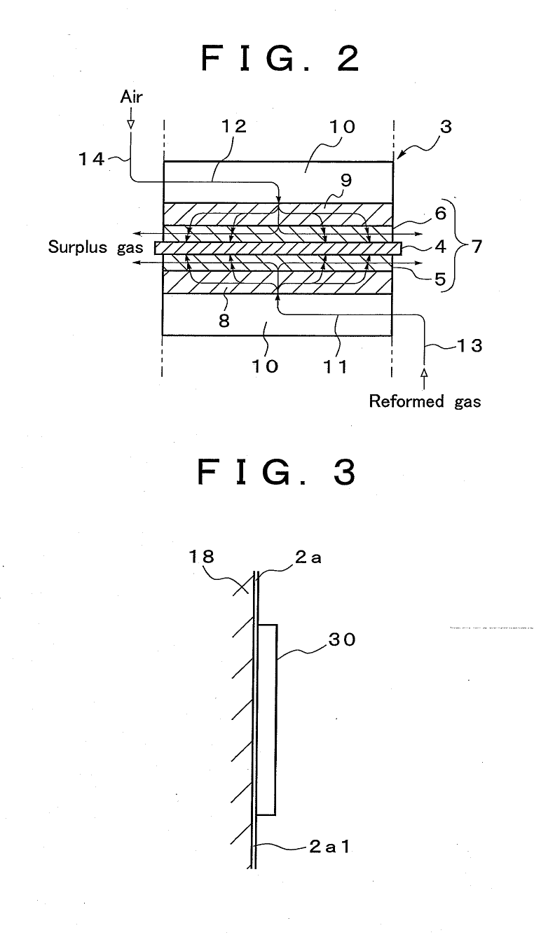

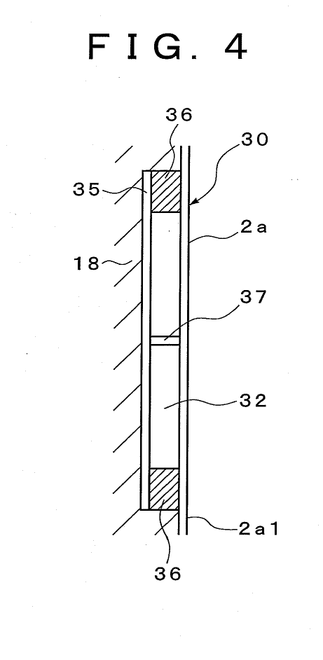

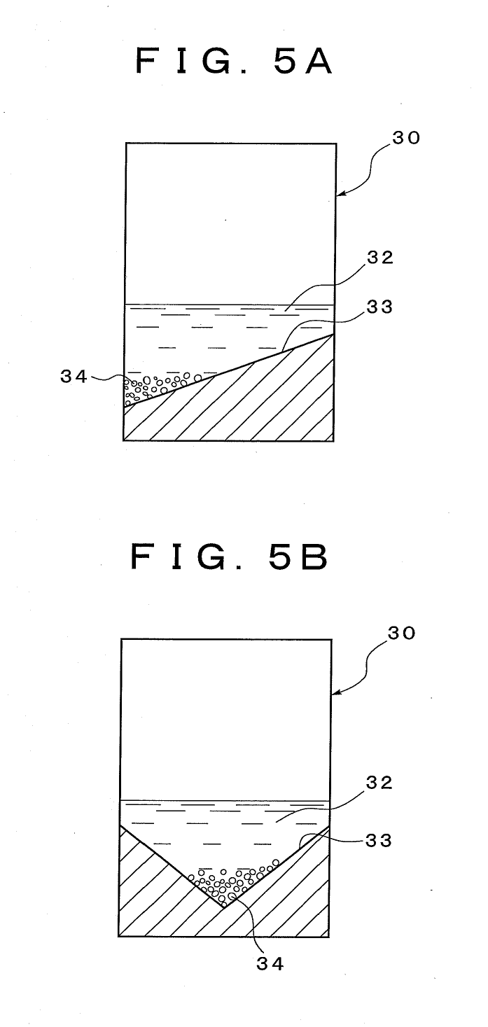

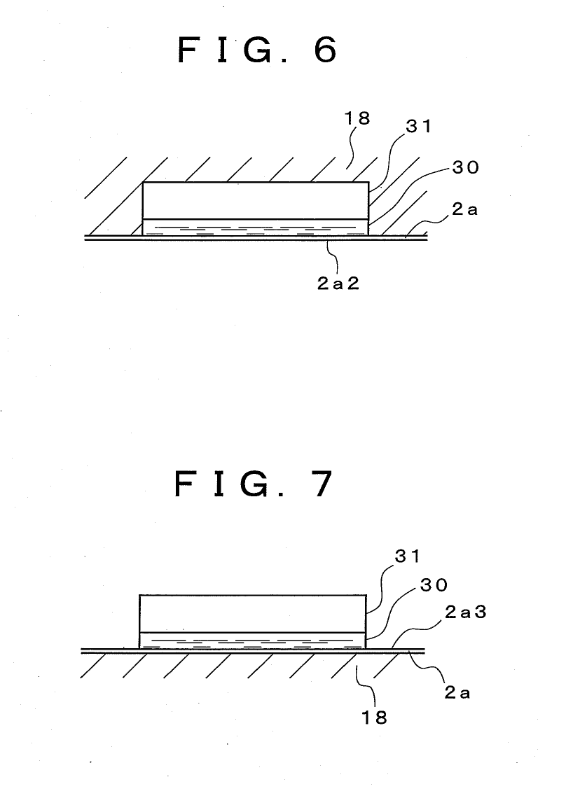

FIG. 1 shows an internal configuration of a solid oxide fuel cell according to the present invention; FIG. 2 shows a configuration of a main part of a fuel cell stack; FIG. 3 shows an embodiment in which a vapor generator is mounted on an outer surface of a side wall of an inner can body; FIG. 4 shows a configuration example of the vapor generator; FIGS. 5A and 5B show inside of the vapor generator; FIG. 6 shows an embodiment in which the vapor generator is mounted on a ceiling wall of the inner can body; and FIG. 7 shows an embodiment in which the vapor generator is mounted on a bottom wall of the inner can body.

In FIG. 1, reference numeral “1” denotes a solid oxide fuel cell, reference numeral “2” denotes a housing comprising a boxy inner can body (container) 2a made of stainless steel and an aluminum outer panel 2b which covers the inner can body 2a, and reference numeral “3” denotes a fuel cell stack which is positioned at the center of the inner can body 2a with the laminating direction being assumed to be vertical. Heat insulating materials 18 which are stacked in layers are positioned between the inner can body 2a and the outer panel 2b so that the fuel cell stack 3 in the inner can body 2a can be kept at high temperature.

As shown in FIG. 2, the fuel cell stack 3 has a structure constructed by laminating a plurality of elements described below in the prescribed order; a power generation cell 7 having a fuel electrode layer 5 and an air electrode layer 6 on both surfaces of a solid electrolyte layer 4, a fuel electrode current collector 8 on the outer side of the fuel electrode layer 5, an air electrode current collector 9 on the outer side of the air electrode layer 6, and separators 10 on the outer side of each of the current collectors 8 and 9.

The solid electrolyte layer 4 is formed of stabilized zirconia (YSZ) doped with yttria, and the like. The fuel electrode layer 5 is formed of a metal such as Ni, or a cermet such as Ni—YSZ. The air electrode layer 6 is formed of LaMnO₃, LaCoO₃ and the like. The fuel electrode current collector 8 is formed of a sponge-like porous sintered metallic plate such as Ni, and the air electrode current collector 9 is formed of a sponge-like porous sintered metallic plate such as Ag. The separator 10 is formed of a stainless steel plate and the like.

The separator 10 has a function of electrically connecting the power generation cells 7, and supplying the reaction gases to the power generation cells 7. The separator 10 has a fuel gas passage 11 for introducing the reformed gas, which is supplied from a reformer 21 described below, through the fuel gas manifold 13 from the outer surface of the separator 10 and discharging the reformed gas from a central portion of the separator 10 facing the fuel electrode current collector 8, and also an air passage 12 for introducing the air, which is supplied from an air heat exchanger 22 described below, through an air manifold 14 from the outer surface of the separator 10 and discharging the air from a central portion of the separator 10 facing the air electrode current collector 9.

The solid oxide type fuel cell 1 adopts a seal-less structure which has no sealing mechanism for gas leakage prevention in the peripheral portion of the power generation cell 7, so that the surplus or residual gas (exhaust gas) remaining unconsumed in the power generating reaction is freely discharged to the outside from the peripheral portion of the power generation cell 7. In addition, as shown in FIG. 1, an exhaust hole 19 is formed on the ceiling of the housing 2 for discharging exhaust gas, which is discharged into the interior of the inner can body 2a, to the outside of the housing 2.

Additionally, in the interior of the inner can body 2a, a fuel heat exchanger 20 for preheating externally-supplied fuel gas, a reformer 21 for steam-reforming the fuel gas, an air heat exchanger 22 for preheating externally-supplied air, and the like are located, along with the fuel cell stack 3 described above.

A fuel gas supply pipe 15 for supplying fuel gas is connected to the inlet of the fuel heat exchanger 20, and the outlet of the fuel heat exchanger 20 is connected to the inlet of the reformer 21 through a pipe 23, and the outlet of the reformer 21 is connected to the fuel gas manifold 13 in the fuel cell stack 3 through a pipe 24. On the other hand, an air supply pipe 16 for supplying air is connected to the inlet of the air heat exchanger 22, and the outlet of the air heat exchanger 22 is connected to the air manifold 14 in the fuel cell stack 3 through a pipe 25.

The heat exchangers 20 and 22 and the reformer 21 are located at appropriate places in the vicinity of the fuel cell stack 3 so that radiation heat can be efficiently received from the fuel cell stack 3. In this embodiment employing the seal-less structure as described above, high temperature exhaust gas is freely discharged into the interior of the inner can body 2a, and therefore heat can be easily recovered by the heat exchangers, and heat exchange structure can be simplified.

On the other hand, a vapor generator 30 for generating steam is mounted on the outer surface (the surface of the heat insulating material 18 side) of the side wall 2a1 of the inner can body 2a, and a steam buffer tank 31 for temporarily storing steam from the vapor generator 30 is mounted on the outer surface (the surface of the heat insulating material 18 side) of the ceiling wall 2a2 of the inner can body 2a.

A water supply pipe 17 for supplying water is connected to the inlet of the vapor generator 30, and the outlet of the vapor generator 30 is connected to the inlet of the steam buffer tank 31 through a pipe 26, and the outlet of the steam buffer tank 31 is connected to a passageway of the fuel gas supply pipe 15 through a steam pipe 27.

In FIG. 1, the vapor generator 30 is mounted to one side wall (left side wall) 2a1 of the inner can body 2a, as described above. Additionally, the vapor generators 30 may be mounted to the other side wall (right side wall) of the inner can body 2a, as denoted by dashed line in FIG. 1. Although not shown in the drawings, the vapor generators 30 can be mounted on the four walls including the left-side and right-side walls (21a1) and also front-side and back-side walls of the inner can body 2a.

Also, as shown in FIG. 3, the vapor generator 30 can be mounted on an inner surface (a surface of the fuel cell stack 3 side) of the side wall 2a1 of the inner can body 2a, instead of the outer surface of the side wall 2a1.

The vapor generator 30 has a flattened, box-shaped body formed of metallic plates (for example, stainless steel plates) having excellent heat resistance and thermal conductivity. A water flow path 32 which lets the introduced water flow from the bottom portion 33 to the upper position is formed inside of the vapor generator 30. The bottom portion 33 of the water flow path 32 are filled with conductive ceramic beads 34 (alumina balls or zirconia balls) up to an elevation where at least the introduced water can be evaporated. Particle size of the ceramic beads 34 is around 1 mm to 2 mm.

In this embodiment, the bottom portion 33 of the water flow path 32 is sloped as shown in FIGS. 5A and 5B. Thus, water is concentrated at the lower portion of the bottom portion 33, when water in the water flow path 32 is deceased.

FIG. 5A shows a configuration in which the bottom portion 33 is sloped to one side, and FIG. 5B shows a configuration in which the bottom portion 33 is sloped in V shape. As far as stability of steam generation is concerned, the configuration shown in FIG. 5B is preferable to that shown in FIG. 5A.

In FIG. 1, the vapor generator 30 is mounted to one side wall 2a1 of the inner can body 2a, as described above. Also, the vapor generators 30 may be mounted to the ceiling wall 2a2 of the inner can body 2a as shown in FIG. 6, or the bottom wall 2a3 of the inner can body 2a as shown in FIG. 7. In these cases, the steam buffer tank 31 can be disposed on the upper surface of the vapor generator 30 as shown in FIGS. 6 and 7.

In FIGS. 1, 3, 6 and 7, the vapor generator 30 is mounted directly to the wall of the inner can body 2a. However, the vapor generators 30 may be mounted to the wall through support members (not shown). At any rate, it is preferable to locate the vapor generator 30 in such a way that water flows along the wall of the inner can body 2a in the planar direction within the water flow path 32, from the viewpoint of effective heat exchange.

Also, as shown in FIG. 4, the water generator 30 can be formed by making a wall (for example, the side wall 2a1) of the inner can body 2a a double walled structure with the use of a metallic plate 35 (for example, a stainless steel plate) having excellent heat resistance and thermal conductivity, and by utilizing a space bounded by the wall of the inner can body 2a and the metallic plates 35 and 36 as a water flow path 32, without using the flattened box-shaped body described above. In FIG. 4, reference numeral “37” denotes a reinforcing rib, which is formed at appropriate position in the water flow path 32.

The vapor generator 30 having such a structure as described above can be applicable not only to the side wall (s) 2a1 of the inner can body 2a but also to the ceiling wall 2a2 and/or the bottom wall 2a3.

In the solid oxide fuel cell 1 described above, fuel gas (for example, city gas), air and water are supplied into the inner can body 2a through the fuel gas supply pipe 15, the air supply pipe 16 and the water supply pipe 17 at the time of operation.

Water is introduced into the vapor generator 30 through the water supply pipe 17, and heated to vaporization in the water flow path 32 by high temperature heat discharged from the fuel cell stack 3. Then, the water in a state of steam goes up in the water flow pass 32, and is introduced into the steam buffer tank 31 through the pipe 26 and temporarily stored in the steam buffer tank 31. The steam in the steam buffer tank 31 is heated further in the tank to become high-temperature steam.

The thus formed high-temperature steam is introduced into the fuel gas supply pipe 15 through the steam pipe 27, and mixed with fuel gas in the fuel gas supply pipe 15 to become mixed gas. The mixed gas is heated by radiation heat from the fuel cell stack 3 in the process of flowing upward in the fuel heat exchanger 20 to become high-temperature mixed gas, and introduced into the reformer 21 through the pipe 23. In the reformer 21, the mixed gas is steam-reformed into hydrogen-rich fuel gas by reforming catalysts. The reformed gas is introduced into the fuel gas manifold 13 in the fuel cell stack 3 through the pipe 24.

On the other hand, air is introduced into the air heat exchanger 22 through the air supply pipe 16, and heated by radiation heat from the fuel cell stack 3 in the process of flowing upward in the air heat exchanger 22, and introduced into the air manifold 14 in the fuel cell stack 3 through the pipe 25. Then, the reformed gas and air are introduced into the respective power generation cells 7 to cause aforementioned electrode reactions in the electrodes of the power generation cells 7.

In the solid oxide fuel cell 1 in this embodiment, since the vapor generator 30 is mounted on the wall of the inner can body 30, the vapor generator 30 can receive exhaust heat radiated from the fuel cell stack 3 efficiently through the wall acting as a heat transfer surface to rapidly generate high-temperature steam, and keep the inside of the inner can body 2a, which tends to be in a state of surplus heat, at favorable operating temperature by the radiating effect due to evaporation.

In particular, since the vapor generator 30 is located in such a way that water in the water flow path 32 flows along the wall of the inner can body 2a in the planar direction, it can receive conductive heat efficiently from the wall and perform an effective heat exchange.

In addition, since the bottom portion 33 of the water flow path 32 is sloped, water in the water flow path 32 is concentrated at the lower portion of the bottom portion 33 and changed into steam in stable condition with a certain amount, when and amount of water in the water flow path 32 is decreased. Further, since the conductive beads 34 are filled in the vapor generator 30, water in the water flow path 32 can be changed into steam rapidly to secure a stable amount of steam, by heat transfer effect of the conductive beads 34.

When the vapor generator 30 is mounted on the inner wall of the inner can body 2a as shown in FIG. 1, the vapor generator 30 can receive radiation heat directly radiated from the fuel cell stack 3 together with conductive heat through the wall of the inner can body 2a. As a result, steam generating performance per unit area can be improved, so that the vapor generator 30 can be downsized.

On the other hand, when the vapor generator 30 is mounted on the outer wall of the inner can body 2a as shown in FIG. 3, steam generating performance per unit area is deteriorated. However, heat insulating performance of the wall of the inner can body 2a can be improved. Thus, the thickness of the heat insulating material 18 arranged on the outside of the inner can body 2a can be reduced, so that the fuel cell can be downsized.

### INDUSTRIAL APPLICABILITY

As described above, the fuel cell according to the present invention can perform efficient heat recovery and effective temperature control in the fuel cell stack.

What is claimed is:

1. An internal reforming type fuel cell comprising: a fuel cell stack constructed by laminating a plurality of power generation cells; and a container accommodating a fuel cell stack therein, wherein reactant gas is supplied to an inside of the fuel cell stack at the time of operation to cause power generating reaction, the fuel cell comprising:
a vapor generator, mounted on a wall of the container, for generating fuel-reforming steam by utilizing exhaust heat from the fuel cell stack as a heat source.

2. The fuel cell according to claim 1, wherein the vapor generator has a water flow path which allows externally-supplied water to flow along a surface of the wall of the container.

3. The fuel cell according to claim 2, wherein a bottom portion of the water flow path is sloped.

4. The fuel cell according to claim 1, wherein conductive beads are placed within the vapor generator.

5. The fuel cell according to claim 1, wherein the vapor generator is mounted on an inner surface of the container.

6. The fuel cell according to claim 1, wherein the vapor generator is mounted on an outer surface of the container.

7. The fuel cell according to claim 1, wherein a steam buffer tank is disposed above the vapor generator for temporary storage of the steam from the vapor generator.

8. The fuel cell according to claim 1, wherein the fuel cell is a solid oxide type fuel cell of a seal-less structure in which exhaust gas is discharged from the outer circumferential part of the power generation cell.
